(19) United States
(12) Patent Application Publication
(10) Pub. No.: US 2009/0101288 A1
(43) Pub. Date: Apr. 23, 2009

(54) Window cover and adjustable shade rail

(76) Inventors: Fu-Lai Yu, San Hsia Town (TW); Chin-Tien Huang, San Hsia Town (TW)

Correspondence Address: Olson & Cepuritis, LTD., 20 NORTH WACKER DRIVE, 36TH FLOOR, CHICAGO, IL, 60606, US

(21) Appl. No.: 11/975,798

(22) Filed: Oct. 22, 2007

(51) Int. Cl. E06B 9/24

(52) U.S. Cl. 160/84.05; 29/428

(57) ABSTRACT

An adjustable shade rail for use with a window covering and method of making the shade rail is provided by combining a first and second rail element. The width of the adjustable shade rail can be adjusted by varying the position of the first rail element in relation to the second rail element.

### FIELD OF INVENTION

The present invention relates to a window covering or window shade containing a rail structure with adjustable dimensions that can be used as a head rail, bottom rail or intermediate rail of a window covering.

### BACKGROUND OF INVENTION

Most commercially available window covering assemblies comprise a head rail located at the top of the window covering. The head rail supports a horizontal shaft that carries the cords or strings that support the window covering fabric or slats. Such a head rail is well known in the art, and one design of a head rail is shown in U.S. Pat. No. 4,531,563.

Most commercially available window covering assemblies also comprise a bottom rail located at the bottom of the window covering. The bottom rail provides weight on the bottom of the window covering to keep the window covering relatively taut. Such a bottom rail is well known in the art, and is shown in various U.S. patents such as U.S. Pat. No. 5,927,366.

Window covering assemblies known in the art also comprise intermediate rails located between adjacent shade panels.

The dimensions of the head rail, bottom rail and intermediate rail vary depending upon the dimensions of the window covering. The window covering has a length measured from top to bottom, a width measured from a first longitudinal side to a second longitudinal side, and a thickness measured from the front side to rear side of the window covering.

The length dimension of the window covering does not affect the dimension of the rail unless the rail is placed along the longitudinal side of the window covering, which is generally not the case. The width dimension of the window covering correlates to the length dimension of the rail, because the length of the rail extends between longitudinal sides of the window covering. The length of the rail can be cut to fit the width of the window covering using various devices known in the prior art.

The thickness dimension of the window covering correlates to the width dimension of the rail, and is the most relevant dimension to this invention. The width of the rail of the present invention is adjusted to correspond to the thickness of the window covering. A window covering with a large thickness requires a rail with an equally large width, whereas a window covering with a small thickness requires a rail with a smaller width.

Unlike the length of the rail, which can be easily cut to fit the width of the window covering, the width of the rail cannot be easily adjusted by cutting. Because a rail generally contains upright structures on its longitudinal sides, the rail can not simply be cut to adjust the width of the rail. Such cutting would remove all or part of the upright structure and render the rail inoperable.

To accommodate various thicknesses of window coverings, window covering manufacturers must generally maintain an inventory of differently-sized rails. These rails are generally of pre-fixed thicknesses configured to correspond to the thicknesses of the various window coverings. A considerable amount of storage space is required to maintain an adequate stock of these differently-sized rails.

In addition, many window covering retailers assemble the window covering at the point of sale. These retailers store various raw window covering materials that are sized to a customer's request and are then combined with the appropriately-sized rails. These retailers must maintain an inventory of various sized rails at the customer sale location in order to assemble the window covering at the point of sale.

Rails of different sizes are difficult to efficiently store, because they cannot be stacked or combined with rails of different sizes. Each specific rail must be stored in its own bin or other identifiable storage location so that it can be adequately accessed. The differently-sized rails must also be organized according to an indexing system that allow the rails to be located by size.

### SUMMARY OF THE INVENTION

The present invention is directed to an adjustable shade rail that can be used for a head rail, bottom rail or intermediate rail of a window covering, and a window covering incorporating this adjustable shade rail. An embodiment of the present invention is a window cover containing a rail system comprised of two rail elements that can be adjustably connected to one another to form a shade rail. It is preferred that the rail elements be identical to reduce inventory, but there can be differences if desired, such as to accommodate a lifting mechanism or a mounting bracket or for appearance.

The rail element preferably comprises a base plate having a top surface and a bottom surface. The base plate can be a continuous structure, or can contain gaps and openings and is preferably generally planar. When not planar, the configuration should be chosen to allow two rail elements to be mounted together such as by matching curved surfaces or a least portions of surfaces which can mate together.

The base plate preferably has a length that generally coincides with the width of the window covering to which the rail will be attached. The length of the base plate can be cut or otherwise altered to correspond to the width of the window covering. The base plate preferably has a width that when combined with the width of a second base plate generally coincides with the thickness of the window covering to which the rail will be attached.

One longitudinal edge of the base plate is preferably perpendicularly connected to an upright flange member. The upright flange member preferably extends above both the top surface and below the bottom surface of the base plate. The upright flange member can extend along the entirety of the longitudinal edge of the base plate or along only a portion of the longitudinal edge. The upright flange need not be continuous, and can contain gaps and openings. In one embodiment of the present invention, the upright flange member has an upper and a lower lip extending generally parallel to the base plate.

The base plate of a first rail element preferably is placed adjacent the base plate of a second rail element such that the bottom surface of one base plate is in overlapping contact with the top surface of the other base plate. In this configuration, the upright flange member of the first base plate is opposite the upright flange member of the second base plate. The two base plates preferably are connected with a connection member to form the adjustable shade rail. The width of the shade rail can be increased by reducing the amount of overlap between the base plates of the two rail elements. The width of the shade rail can be decreased by increasing the amount of overlap between the base plates of the two rail elements.

The base plates of the present invention may also include frictional engagement members on either its bottom surface or top surface or on both surfaces. These frictional engagement members preferably engage the complementary frictional engagement members on the overlapping second base plate in a manner that prevents slipping displacements between the two rail elements. The frictional engagement members can be formed in a variety of configurations. For example, the frictional engagement members can be a generally striated pattern containing grooves and teeth. The grooves and teeth can be of any shape and the distance between each tooth or groove can vary. The frictional engagement member can be of any other configuration that prevents the slipping displacement between the two rail elements.

The window covering in which the adjustable shade rail is incorporated preferably contains a shade element, control cords and bracket members to attach the window covering to separate structure. The shade element may be of any type known in the art, including venetian blinds, roman-style shades, and honeycomb cellular shades.

The adjustable shade rail can be attached to the shade element in a variety of manners. Generally, the upright flange members of the shade rails are adapted to receive a portion of the shade element. In particular, a portion of the shade element is inserted into the space between the flange member of the first rail element and the flange member of the second rail element, and the shade element is attached to the upright flange members. The lips of the upright flange members can also be used to attach the shade member to the adjustable shade rail.

The adjustable shade rail portion of the present invention reduces the amount of storage space previously required for the shade rails of the prior art. The rail elements of the present invention are easily stored because they can be combined with other identical or similar rail elements in the same storage space. The rail elements of the present invention also require little or no cataloging or other organizational indexing, because the rail elements are of the same or similar sizes and configurations.

Accordingly, the present invention provides an adjustable shade rail that requires a small amount of storage space and that can be customized to a desired width quickly and easily, and a window cover containing this adjustable shade rail.

### BRIEF DESCRIPTION OF THE DRAWINGS

In the drawings,

FIG. 1 is a partial perspective view of a rail element in accordance with an embodiment of the present invention;

FIG. 2 is the reverse partial perspective view of the rail element shown in FIG. 1;

FIG. 3 is a partial perspective view of two rail elements attached to form an adjustable shade rail of the present invention;

FIG. 4 is a partial side elevation view of the adjustable shade rail shown in FIG. 3;

FIG. 5 is a partial side elevation view of another embodiment of the adjustable shade rail of the present invention;

FIG. 6 is a partial side elevation view of another embodiment of the adjustable shade rail of the present invention;

FIG. 7 is partial perspective view of a window covering wherein the adjustable shade rail of FIG. 3 acts as an intermediate rail;

FIG. 7a is a magnified view of the end portion of the window covering showing in FIG. 7;

FIG. 8 is a side elevation view of a window covering wherein the adjustable shade rail of FIG. 3 acts as a head rail; and

FIG. 9 is a plan view of the window covering of FIG. 3 wherein the adjustable shade rail acts as a head rail.

### DESCRIPTION OF PREFERRED EMBODIMENT

The invention disclosed herein is susceptible to embodiment in many different forms. The embodiments shown in the drawings and described in detail below are only for illustrative purposes. The disclosures are intended as an exemplification of the principles and features of the invention, but do not limit the invention to the illustrated embodiments.

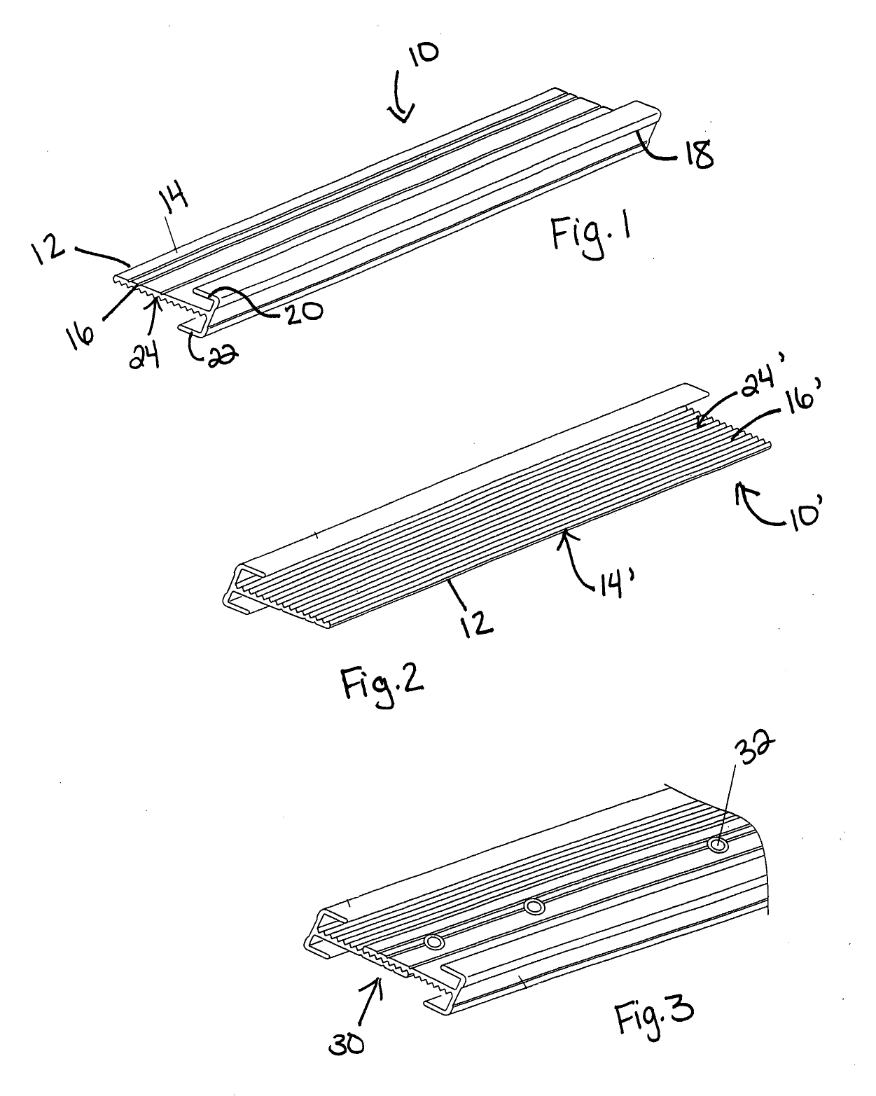

Referring to FIG. 1, a rail element 10 adapted for use with a window covering is shown. Rail element 10 includes a base plate 12 having a first surface 14 and a second surface 16. The base plate is preferably planar and generally flat. When not planar, the configuration should be chosen to allow two rail elements to be mounted together. Such a configuration can include matching curved surfaces which complement each other when stacked.

The base plate can also contain a staggered off-set portion created from a perpendicular turn along the surface of the base plate followed by another perpendicular turn that returns the base plate to a parallel position with relation to the rest of the base plate. The off-set base plate is generally “S”-shaped with straight edges and ninety degree turns rather than rolling curved portions. The off-set portion of the base plate is complementary to the off-set portion of another base plate, and advantageously limits the amount of lateral adjustment available to the width of the assembled head rail.

Yet another embodiment of the base plate can include a double plate configuration such that the base plate defines two generally parallel and distinct structures. Both of the structures contain a first surface and a second surface. Two base-plates with double cell configurations can be mated in a complementary male-female coupling.

The base plate 12 can be continuous as shown in FIG. 1, but can also contain gaps and openings (not shown).

An upright flange member 18 is connected to a longitudinal edge of the base plate 12. The upright flange member 18 is preferably perpendicular to the base plate 12, and preferably extends above both the top surface and below the bottom surface of the base plate. The base plate 12 can be attached to the lateral centerline of the upright flange member 18, as shown in FIG. 1. The base plate 12 can also be attached above or below the lateral centerline of the upright flange member 18 one-half the thickness of the base plate so that the size of the flange member extending above the base plate is not equal to the size extending below the base plate (not shown). Such a non-centered configuration can be advantageously utilized to create a head rail in which the upright flange members of two base plates are even and symmetrical. The uncentered upright flange member compensates for the displacement caused when two base plates are connected to create a head rail, and allows the overall head rail to be symmetrical even though the individual rail element 10 is unsymmetrical.

The upright flange member can be continuous as shown in FIG. 1, but can also contain gaps and openings (not shown).

In one embodiment of the present invention, the upright flange member 18 has a first lip portion 20 and a second lip portion 22. The first and second lip portions 20, 22 can be continuous or can contain gaps and openings as well. The first and second lip portions 20, 22 preferably are generally parallel to the base plate 12. When the base plate 12 is attached to the lateral centerline of the upright flange member 18, the first lip portion 20 and the second lip portion 22 are equidistant from the base plate 12. When the base plate 12 is attached above the lateral centerline of the upright flange member 18, the distance between the first lip portion 20 and the base plate 12 is smaller than the distance between the second lip portion 20 and the base plate 12. The opposite is true when the base plate 12 is attached below the lateral centerline of the upright flange member 18.

In one of the embodiments of the present invention, at least one of the first surface 14 or second surface 16 of the base plate 12 includes frictional engagement members such as a striated pattern 24. The striated pattern 24 can be formed from a generally V-shaped tooth and groove pattern as shown in FIGS. 1 and 2. The striated pattern 24 can also be formed from any other configuration suitable for frictional contact, such as a U-shaped tooth and groove pattern or tab and slot pattern (not shown).

Referring to FIG. 2, a second rail element 10′ is shown that is the same as rail element 10. Rail element 10′ is shown in a position opposite that of the rail element 10 shown in FIG. 1 such that the second surface 16′ of the base plate of rail element 10′ is facing toward the second surface 16 of the base plate of second rail element 10. The second surface 16′ of the base plate of rail element 10′ contains striated pattern 24′ complementary to striated pattern 24.

In another embodiment (not shown), rails 10, 10′ can contain frictional engagement members on the first surface 14, 14′ of the base plates so that second rail element 10′ does not have to be placed into a reverse configuration to engage the frictional engagement members of rail element 10′.

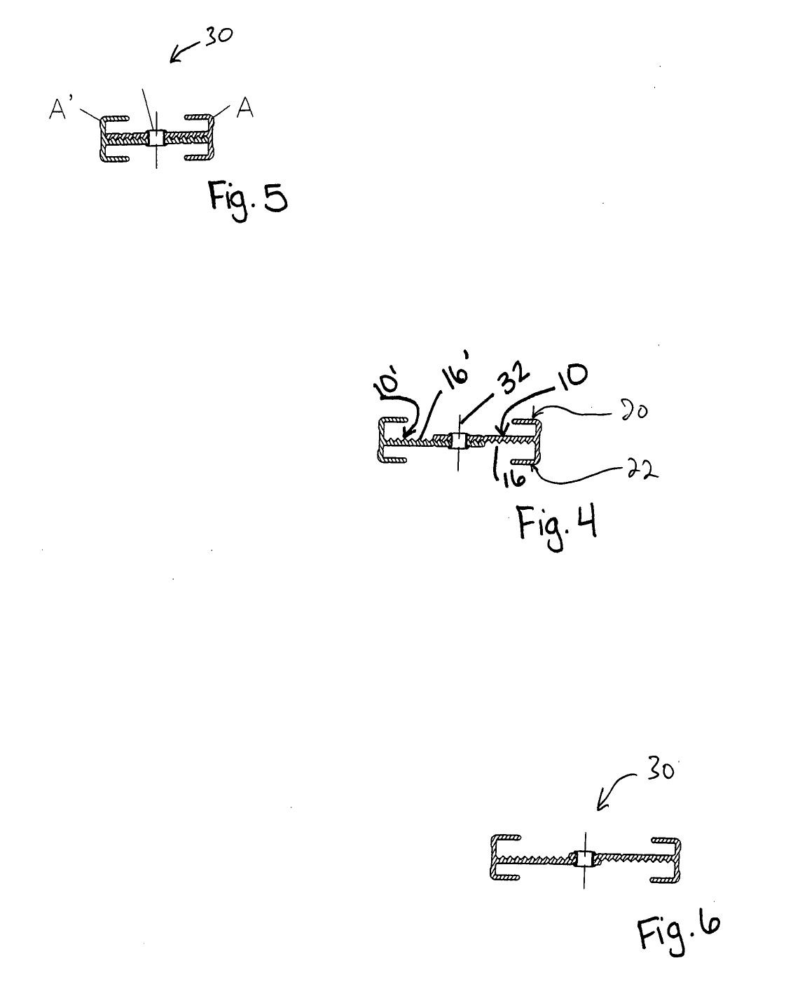

Referring to FIGS. 3 and 4, an assembled adjustable shade rail 30 is shown. The adjustable shade rail 20 is preferably formed by connecting two rail elements 10. Adjustable shade rail 30 includes rail element 10, second rail element 10′ and fastener element 32. The upright flange members of the embodiment of the invention shown in FIGS. 3 and 4 contain first and second lip portions 20,22 that extend generally parallel to the base plate 12. The present invention is not limited to an embodiment with this particular configuration.

The base plates 12 and 12′ of the rail members are placed adjacent one another so that a portion of second surface 16 of rail element 10 touches a portion of second surface 16′ of second rail element 10′.

In an embodiment of the present invention containing a striated pattern 24 on the base plate 12 (as shown in FIGS. 1-4), the striated pattern 24 mates with the striated pattern 24′ of rail element 10′ to hold the rail elements in desired lateral position and help prevent lateral displacements between the rail elements 10 and 10′. The striated pattern 24 shown in FIGS. 1-6 preferably is formed from a generally V-shaped tooth and groove pattern. The striated pattern 24 can also be formed from any other configuration suitable for frictional contact, such as a U-shaped tooth and groove pattern or tab and slot pattern (not shown).

Rail elements 10 and 10′ of the adjustable shade rail 30 are preferably connected to each other by fastener element 32. Fastener element 32 can be a conventional rivet know in the art (as shown). Fastener element 32 in the embodiment shown in FIGS. 3-6 extends through both surfaces 14,16 and 14′,16′ of rail elements 10,10′.

Fastener element 32 can also be any other device known in the art that creates mechanical connections, such as a screw, staple or wire (not shown). A mechanical connector that does not pass through the surfaces of the rail elements can also be used, such as a mechanical clamp. One or more mechanical clamps can be used to secure rail elements 10, 10′ and can be placed anywhere to achieve such securement. In another embodiment, the fastener element 32 can be an adhesive, solder, weld or elastomeric band (not shown).

The width of the adjustable shade rail 30 preferably is determined by the amount of overlap between base plate 12 of rail element 10 and base plate 12′ of rail element 10′. In the embodiment shown in FIGS. 3 and 4, shade rail 30 has a generally intermediate width created by the intermediate overlap of base plates 12, 12′.

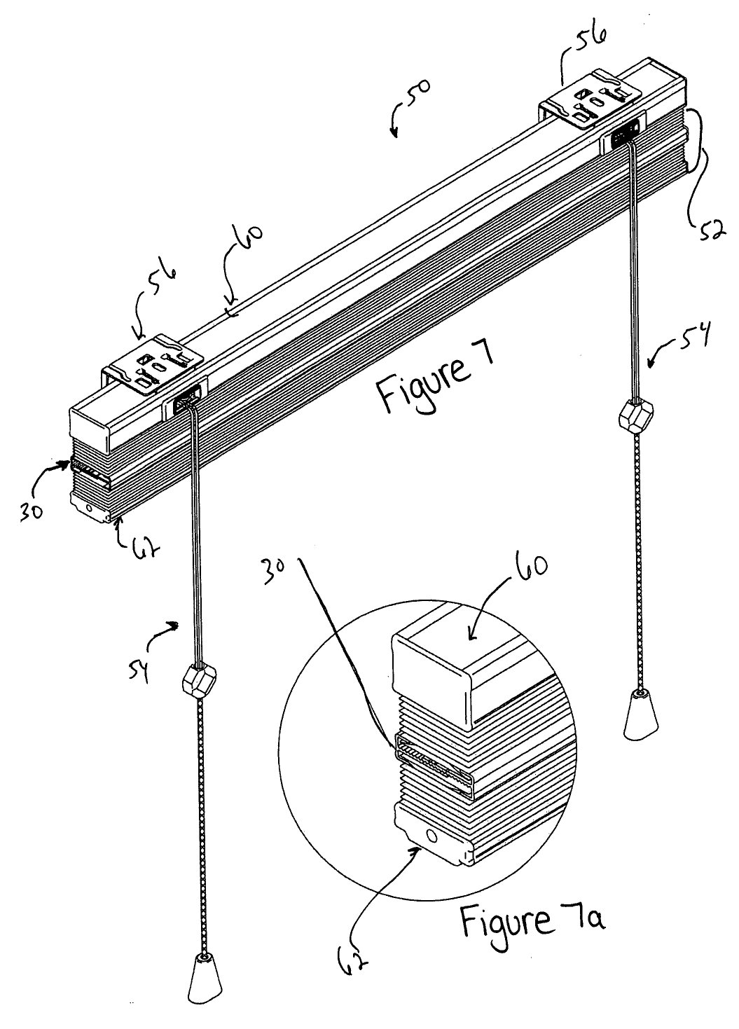

The width of the adjustable shade rail 30 can be decreased by increasing the amount of overlap between base plates 12, 12′. Referring to FIG. 5, the overlap of base plates 12, 12′ is at its maximum limit, and therefore the width of adjustable shade rail 30 is as short as physically possible for this particular embodiment of the present invention.

The width of the adjustable shade rail 30 can be increased by decreasing the amount of overlap between base plates 12, 12′. Referring to FIG. 6, the overlap of base plates 12, 12′ is at its minimum limit, and therefore the width of adjustable shade rail 30 is as large as physically possible for this particular embodiment of the present invention.

The components of the adjustable shade rail 30 may be constructed of any suitable material, including metal, plastic or wood.

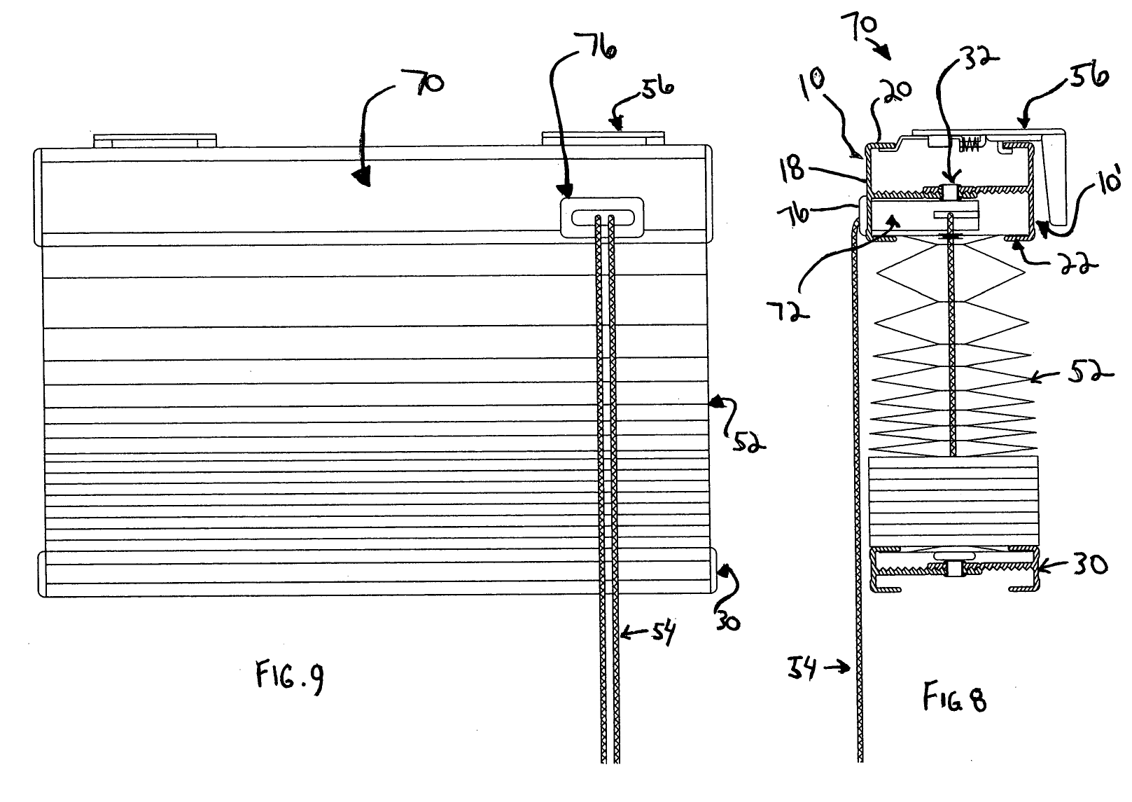

Referring to FIG. 7 and FIG. 7a, window covering 50 containing the adjustable shade rail 30 is shown. Window covering 50 preferably includes a shade element 52, which can be any type of shade or blind material known in the art, including but not limited to venetian blinds, roman-style shades and honeycomb cellular shades.

Window covering 50 can also contain control cords 54, which can be any type of control device known in the art, including but not limited to an opening cord, a raising cord, or a securement cord. Window covering 50 can also have a “cordless” construction as known in the art, in which case the control cords 54 would not be present.

Window covering 50 can also contain brackets 56, which can be any type of device known in the art used to attach a window covering to a separate structure. Window covering 50 can also have a “bracketless” construction as known in the art, in which case the window covering 50 can be directly attached to a separate structure by screws, nails, adhesives or other such devices that are attached directly to the window covering 50.

The particular window covering 50 shown in FIG. 7 and FIG. 7a contains a head rail 60 and a bottom rail 62. The adjustable shade rail 30 is used as an intermediate rail in the embodiment shown in FIG. 7 and FIG. 7a. The intermediate rail is located in the middle of shade element 52. This intermediate rail can be used, for example, to attach two different types of shade element material together or to attach the same type of shade element material together.

The adjustable shade rail 30 can also be used as the bottom rail or head rail of the window covering. In an alternative embodiment shown in FIGS. 8 and 9, the adjustable shade rail 30 is positioned at the bottom of the shade element 52 and a separate bottom rail 62 is not be present. An adjustable shade rail 30 used as a bottom rail can include supplemental structure that provides weight to keep the window covering relatively taught.

The adjustable shade rail may also be used as an adjustable head rail 70 in the embodiment shown FIGS. 8 and 9. In the embodiment shown, control module 72 is mounted in the space created between the lower lip 22 and the base plate 12 of the first rail element 10. It can be attached to the rail by the same fastener used to connect the two rails. In an alternative embodiment (not shown), control module 72 may be mounted between the upper lip 20 of either the first or second rail element 10, 10′. Control module 72 and other hardware can be placed in any of the spaces of adjustable head rail 70. The upright flange member 18 of at least one rail element 10 of the adjustable head rail 70 contains at least one opening 76 that allow passage of control cords 54.

The adjustable shade rail 30 can be used for all of the rails or only a portion of the rails in a window covering.

The adjustable shade rail can be attached to the shade element in a variety of manners. Generally, the upright flange members 18 of the shade rails are adapted to receive a portion of the shade element 52. As shown in the embodiment of FIG. 8, a portion of the shade element 52 is inserted into the space between the upright flange member 18 of the first rail element and the upright flange member of the second rail element. The lips 20, 22 of the upright flange members 18 can also be used to attach the shade member 52 to the adjustable shade rail 30. As shown in the embodiment of FIG. 8, lips 20, 22 can also be used to assist in securing the shade element 52 to the adjustable shade rail 30.

The foregoing description and the drawings are illustrative of the present invention and are not to be taken as limiting. Other arrangements of the engagement structure may be implemented. Such variations and modifications are within the spirit and the scope of the present invention and will be readily apparent to those skilled in the art in view of the scope of the invention as claimed herein.

What is claimed is:

1. A window covering comprising:
a shade element,
a rail assembly including a first rail element and a second rail element,
wherein each of the first and second rail elements includes a base plate having a length, and a flange member connected to an end portion of the base plate along the length of the base plate and adapted to receive a portion of the shade element, and
wherein the base plate of the first rail element is in overlapping contact with the base plate of the second rail element with a portion of the shade element being engaged by the flange members of the rail elements, and
a fastener element securing the base plate of the first rail element to the base plate of the second rail element.

2. The window covering of claim 1, wherein the base plates of the first and second rail elements includes frictional engagement members that engage each other.

3. The window covering of claim 2, wherein the frictional engagement members define a striated pattern.

4. The window covering of claim 1, wherein the base plate defines at least one aperture.

5. The window covering of claim 1, wherein the flange member defines at least one aperture.

6. The window covering of claim 1, wherein the flange member is attached to the shade element by extending at least a portion of the flange member through at least a portion of the shade element.

7. The window covering of claim 1, wherein an amount of overlap between the base plate of the first rail element and the base plate of the second rail element is set according to a dimension of the shade element.

8. The window covering of claim 1, wherein the flange member is generally perpendicular to the base plate.

9. The window covering of claim 1, wherein the flange member extends on opposite sides of the base plate.

10. The window covering of claim 1, wherein each of the flange members include at least one lip portion that is generally parallel to the base plate.

11. The window covering of claim 10, wherein the lip portion is adapted to securely retain a portion of the shade element in the rail assembly.

12. The window covering of claim 1, wherein a portion of a first shade element is received by a portion of the flange member extending above the base plate and a portion of a second shade element is received by a portion of the flange member extending below the base plate.

13. The window covering of claim 1, further comprising a control module dimensioned to fit between the flange member of the first rail element and the flange member of the second rail element.

14. The window covering of claim 1, wherein the shade element includes a honeycomb panel.

15. The window covering of claim 1, wherein the fastener element is one of an adhesive, solder, weld, elastomeric band or mechanical clamp.

16. A rail element used for fabricating a rail assembly in a window covering, the rail element comprising:
a generally flat base plate having a top surface and a bottom surface wherein at least one of the top or bottom surface includes a striated pattern,
a flange member perpendicularly connected to a longitudinal edge of the base plate and extending above the top surface and below the bottom surface of the base plate,
an upper lip extending perpendicularly from a top longitudinal edge of the flange member,
a lower lip extending perpendicularly from a bottom longitudinal edge of the flange member, and
the base member, flange member, upper lip and lower lip being formed in a single body.

17. The rail element of claim 16, wherein at least one of the upper or lower lip of the flange member is configured to retain a portion of a shade element between the base plate and the at least one upper or lower lip.

18. A method of assembling a window covering shade rail comprising:
selecting a first and second rail element, wherein each rail element includes a base plate and a flange member connected along at least a portion of one edge of the base plate and adapted to receive a portion of the shade element,
positioning the first rail element adjacent the second rail element,
adjusting the position of the first rail element to overlap a portion of the second rail element,
securing the first rail element to the second rail element,
inserting a portion of a shade element into the space between the flange member of the first rail element and the flange member of the second rail element,
securing the shade element to the flange members of the first and second rail elements, and
attaching at least one control cord and at least one bracket member to the shade element.

19. The method of claim 18, further comprising cutting the length of the first and second rail elements to coincide with a dimension of the shade element.

20. The method of claim 18, further comprising securing the first rail element to the second rail element by a fastener element extending through a portion of the first and second rail element.
